(19) United States
(12) Patent Application Publication
(10) Pub. No.: US 2013/0293052 A1
(43) Pub. Date: Nov. 7, 2013

(54) MAGNET RETENTION ON ROTORS

(71) Applicant: COMPREHENSIVE POWER, INC., Marlborough, MA (US)

(72) Inventors: Andrew I. Nehring, Northborough, MA (US); Stuart A. Jones, Duxbury, MA (US); Franklin B. Jones, Shrewsbury, MA (US)

(21) Appl. No.: 13/874,570

(22) Filed: May 1, 2013

Related U.S. Application Data
(60) Provisional application No. 61/642,647, filed on May 4, 2012.

(51) Int. Cl. H02K 1/27; H02K 15/03

(52) U.S. Cl. CPC H02K 1/27; H02K 15/03
USPC 310/156.08; 29/598

(57) ABSTRACT

A rotor magnet retention device comprises a retainer body and a fastening device. The retainer body includes a bottom region, at least two angled side regions extending from the bottom region, and at least one opening extending through a bottom surface of the retainer body. The fastening device extends through the opening at a bottom surface of the retainer body to a rotor to flexibly position the retainer body relative to the rotor. A first angled side surface conformably communicates with a first magnet coupled to the rotor and a second angled side surface conformably communicates with a second magnet coupled to the rotor.

This application claims the benefit of U.S. provisional patent application No. 61/642,647 filed on May 4, 2012 and entitled “Magnet Retention on Rotors”, the contents of which are incorporated by reference in their entirety. This application is related to U.S. patent application Ser. No. 11/385,381 filed Mar. 21, 2006, issued as U.S. Pat. No. 7,285,890 on Oct. 23, 2007, entitled “Magnet Retention on Rotors,” the entirety of which is incorporated herein by reference.

### FIELD OF THE INVENTION

The present invention relates generally to permanent magnet motors. More particularly, the present invention relates to retaining magnets on rotors useful in permanent magnet motors.

### BACKGROUND OF THE INVENTION

A permanent magnet motor consists of a wound stator within which a rotor rotates. Permanent magnets are attached to the rotor to produce alternating north and south magnetic fields that interact with electrical current through the stator to produce torque. The permanent magnets are attracted to the steel core of the rotor. However, centrifugal forces can occur during rotation of the rotor.

Magnet retention is difficult, and involves several factors. First, the magnets are brittle ceramics and structurally weak. Second, the centrifugal forces are high, especially with very high-speed rotors. Third, radial space (i.e., the space between the rotor and the stator) is at a premium because the magnetic field weakens as the radial separation between the rotor and stator increases. Fourth, permanent magnet motors frequently are required to operate in environments spanning a wide range of temperatures and the rates of thermal expansion of the components of the rotor may differ substantially over the temperature range.

Many methods have been proposed to retain magnets on rotors. Magnets can be bonded to the surface of the rotor, and then held in place by an outer wrap of high-strength material such as glass or carbon fiber, typically with an encapsulant filling the spaces between magnets. These methods have a drawback in that the thickness of the wrap reduces the mechanical clearance (i.e., the radial space) between the stator and rotor. Also, the expansion rate of the wrap under tension and temperature makes it difficult to keep the adhesive bond in compression at high rotational speed. In the absence of compression the adhesive bond can peel, which then allows the magnets to move axially. Since these approaches depend on the integrity of the outer wrap, it is not feasible to repair or replace a magnet after the rotor has been built. Other conventional methods are provided that do not include the outer wrap. Conventional approaches may eliminate the radial thickness penalty of the approaches described above, but rely on the encapsulant and bond for retention.

Another prior art approach discloses a detachable magnet carrier to hold the magnets. Here, the magnets are packaged in a stainless steel box that provides structural strength. This is an expensive approach, and the thickness of the box subtracts from the radial clearance between the rotor and stator.

Magnets can also be contained inside of the rotor, such that the rotor structure retains the magnets. Interior magnet constructions require compromises in the magnetic circuit that reduce performance in some applications.

Accordingly, there still exists a need in industry for a magnet mounting method and structure that places the magnets on the surface of the rotor, using a minimal radial thickness of structural material, so that the performance of the magnetic circuit is maximized. Further, the mounting should maintain compression on the magnets under a wide range of rotational speeds and temperatures, avoiding excessive mechanical stress on the brittle ceramic magnets. Finally, the mounting should allow the replacement of individual magnets after the rotor has been built.

### SUMMARY OF THE INVENTION

In accordance with an aspect, provided is a retainer and method for holding a magnet to a rotor of an electric motor. More specifically, the retainer can maintain an adhesive bonding layer between the magnet and rotor in compression over wide variations in temperature and speed of rotation. The retainer includes a retainer body having a stamped profile, including a bottom region and at least two angled side regions extending from the bottom region. A fastening device extends through an opening at a bottom surface of the retainer body. Each angled side surface conformably communicates with a magnet surface when the retainer body is secured to the rotor by the fastening device. A spring mechanism is positioned between a top portion of the fastening device and the opening to provide a force reactive to a centrifugal force during rotation of the rotor. The stamped profile of the retainer body provides a spring displacement to reduce the spring travel otherwise required at the fastener. The angled side surface can have a different angle than an angle of the magnet surface, whereby the angled side surface of the retainer can flex, for example, displace, deform, or the like, to adapt to the magnet surface.

In an aspect, the present inventive concepts embody a rotor magnet retention device, comprising: a retainer body and a fastening device. The retainer body includes a bottom region and at least two angled side regions extending from the bottom region, the retainer body including at least one opening extending through a bottom surface of the retainer body. The device further comprises a fastening device that extends through the opening at a bottom surface of the retainer body to a rotor to flexibly position the retainer body relative to the rotor. A first angled side surface conformably communicates with a first magnet coupled to the rotor and a second angled side surface conformably communicates with a second magnet coupled to the rotor.

In another aspect, the present inventive concepts embody a method for holding a magnet to a rotor. The method comprises positioning a retainer body between a first magnet and a second magnet, the first and second magnets each coupled to a rotor. The retainer body includes a bottom region and at least two angled side regions extending from the bottom region. The retainer body includes at least one opening extending through a bottom surface of the retainer body. A first angled side surface conformably communicates with the first magnet. A second angled side surface conformably communicates with the second magnet. The method also comprises extending the fastening device through the opening at the bottom surface of the retainer body to the rotor; applying a centrifugal force to the retainer body in response to a rotation of the rotor, which, in response moves in a direction towards the rotor; and generating, at the fastening device, a centripetal force on the retainer body that counters the centrifugal force.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not meant to limit the scope of the invention. For clarity, not every element may be labeled in every figure. The drawings are not necessarily to scale, emphasis instead being placed upon illustrating the principles of the invention.

FIG. 1 is a perspective view of a retainer body of a magnet retainer, in accordance with an embodiment of the present inventive concepts;

FIG. 2 is a top view of the retainer body of FIG. 1;

FIG. 3 is a front view of the retainer body of FIGS. 1 and 2;

FIG. 4 is a perspective view of a plurality of bolts positioned in openings of a retainer body, in accordance with an embodiment of the present inventive concepts;

FIG. 5 is a front view of the retainer body and the bolts of FIG. 4;

FIG. 6 is a front view illustrating a spring action performed by a retainer body in response to a force applied to the retainer body, in accordance with an embodiment of the present inventive concepts;

FIG. 7 is a perspective view of a retainer secured to a rotor of an electric motor, in accordance with an embodiment of the present inventive concepts; and

FIG. 8 is a front view of the retainer and the rotor of FIG. 7.

### DETAILED DESCRIPTION OF THE INVENTION

In accordance with embodiments of the present invention, novel devices and methods for retaining magnets on a rotor of a permanent magnet motor are provided. The magnets can be disposed on the cylindrical surface at equal intervals around the circumference of the cylindrical surface. An adhesive layer is disposed between the magnet and the cylindrical surface. The magnet retainers are disposed between each pair of magnets and secured to the rotor body. The magnet retainers can be inserted between each pair of magnets separated by an angular interval. The magnets on each side of a magnet retainer are collectively referred to herein as a neighboring pair of magnets.

Magnet retainers, for example, described in U.S. Pat. No. 7,285,890 issued Oct. 23, 2007 and entitled “Magnet Retention on Rotors,” incorporated by reference herein in its entirety, can comprise a machined block-shaped retainer body having an angled surface adapted for engaging an angled surface of a magnet when the retainer body is secured to the rotor. However, the block-shaped retainer body is typically made of a substantial amount of a costly material such as stainless steel. The block-shaped retainer body typically substantially fills the regions between the neighboring magnets secured against the rotor body by the retainer body.

The magnet retainers in accordance with embodiments of the present invention, on the other hand, can be constructed and arranged to have a stamped profile, either formed from heat treated metals, or stamped, formed, and subsequently heat treated. Accordingly, the stamped retainers have a reduced profile as compared to conventional machined retainers, which can reduce fabrication costs. The stamped profile of a magnet retainer in accordance with an embodiment also provides for a spring displacement, which can reduce the spring travel needed at a fastening device, for example, bolts and Belleville washers holding the retainer against the rotor body. Thus, less demand is placed on the Belleville washer springs as compared to conventional solid block retainers. In another embodiment, retainer spring displacement also allows the retainer to accept a wider magnet chamfer tolerance, reducing the cost and reject rate of the magnets.

Also, the stamped profile of the retainer permits the retainer to be formed of high-strength, non-magnetic materials such as Inconel, Monel, or other nickel based alloys regardless of whether these materials otherwise lack the machinability characteristics of stainless steel and the like typically required for the formation of conventional retainers. Accordingly, improved magnetic circuit performance and safer assembly processes are achieved over conventional approaches.

Also, the reduced weight of the stamped retainer in accordance with embodiments over machined stainless steel retainer blocks such as those described in U.S. Pat. No. 7,285,890 incorporated by reference herein can result it a smaller rotor moment of inertia, allowing for quicker starts and stops, and higher angular acceleration with the same provided torque.

When a magnet retainer in accordance with embodiments of the present inventive concepts is engaged with a magnet surface, the angled surfaces of the magnet retainers can provide a force, for example, press down, on the angled surfaces on the magnets, whereby a centripetal force is exerted on the magnets that pulls the magnets in a direction of the surface of the rotor, which can exert a compressive force on the adhesive layer between the magnets and the rotor body. In an embodiment, the body of each magnet retainer comprises two angled surfaces, each angled surface engaging an angled surface on one of the neighboring pair of magnets. The length and angle of the engaged angled surfaces are selected to keep the mechanical stress within the magnets to an acceptably low level, and can be established by one of ordinary skill in the art.

In an embodiment, a compliant layer is positioned between the magnet's angled surface and the angled surface of the retainer body. The compliant layer can assist in distributing the centripetal force more uniformly across the angle surfaces, limiting the contact stress concentrations. The compliant layer can comprise an epoxy coating, for example, on the angled surface(s) of each magnet.

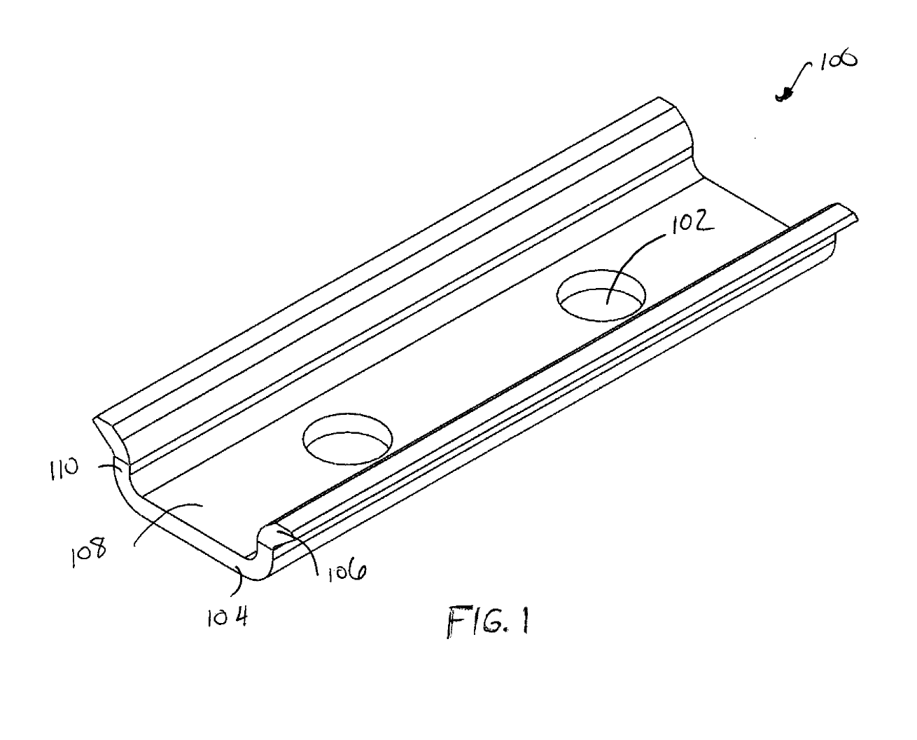

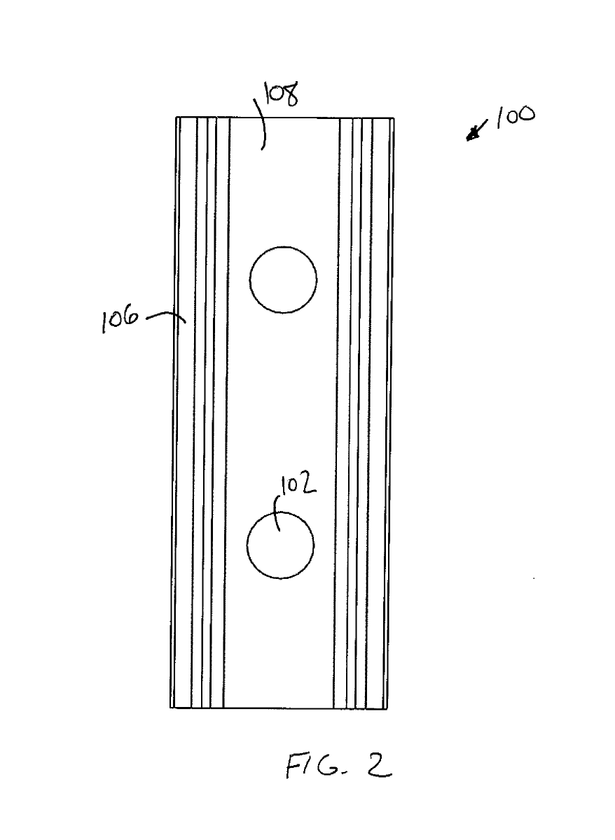

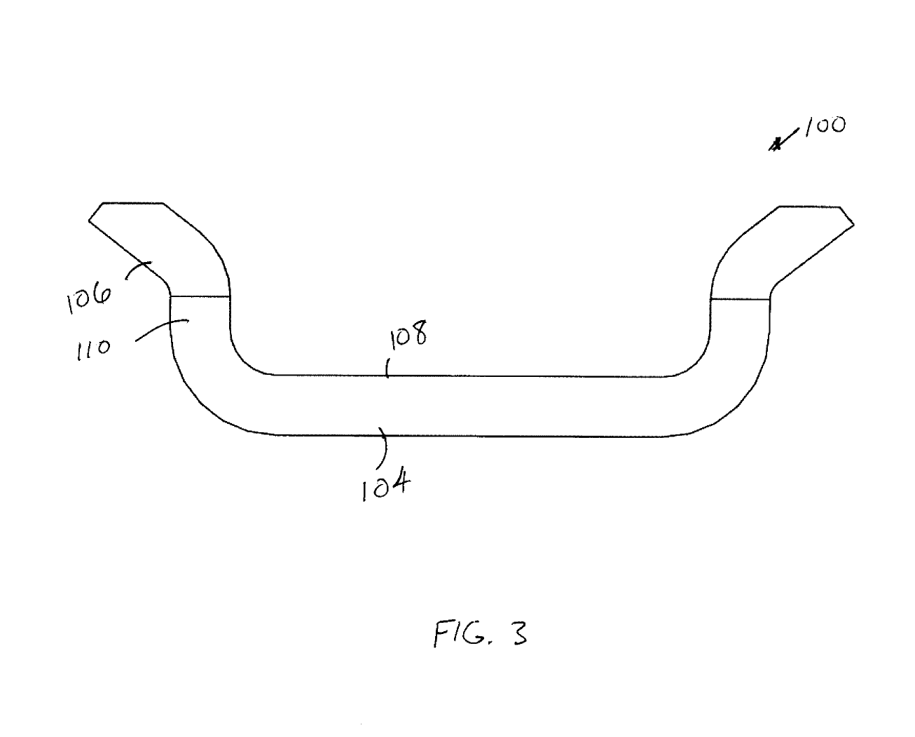

FIG. 1 is a perspective view of a retainer body 100 of a magnet retainer, in accordance with an embodiment of the present inventive concepts. FIG. 2 is a top view of the retainer body 100 of FIG. 1. FIG. 3 is a front view of the retainer body 100 of FIGS. 1 and 2. The retainer body 100 is preferably stamped, and can therefore be formed of materials not well-suited for machining, such as nickel-based alloys, Inconel, Monel, and related materials known to those of ordinary skill in the art. The retainer body 100 can be formed from heat treated metals. Alternatively, the retainer body 100 can be stamped and formed, then heat treated.

The retainer body 100 has one or more openings 102 for accepting fastening devices, such as a bolt. The openings 102 can be cylindrical or other shape permitting the receipt of a fastening device. The openings 102 extend through a bottom portion 104 of the retainer body 100. The bottom portion 104 can be U-shaped or the like, and can include two side surfaces 110 and a surface 108 between the side surfaces 110. Two angled side surfaces 106 can extend from the side surfaces 110. The angled side surfaces 106 can be formed separately from the bottom portion 104 and/or side surfaces 110, and can be coupled to the side surfaces 110 of the bottom portion 104 by bonding, welding, or other coupling technique. The angled side surfaces 106 can be formed of the same or similar materials, or different materials, than the bottom portion 104. Alternatively, the angled side surfaces 106 and the bottom portion 104 can be formed of a common stock, and machined, molded, or otherwise formed together from a single material. The bottom portion 104 and the angled side surfaces 106 can have a same width, thickness, length, or other dimensions. Alternatively, the bottom portion 104 and the angled side surfaces 106 can have different dimensions.

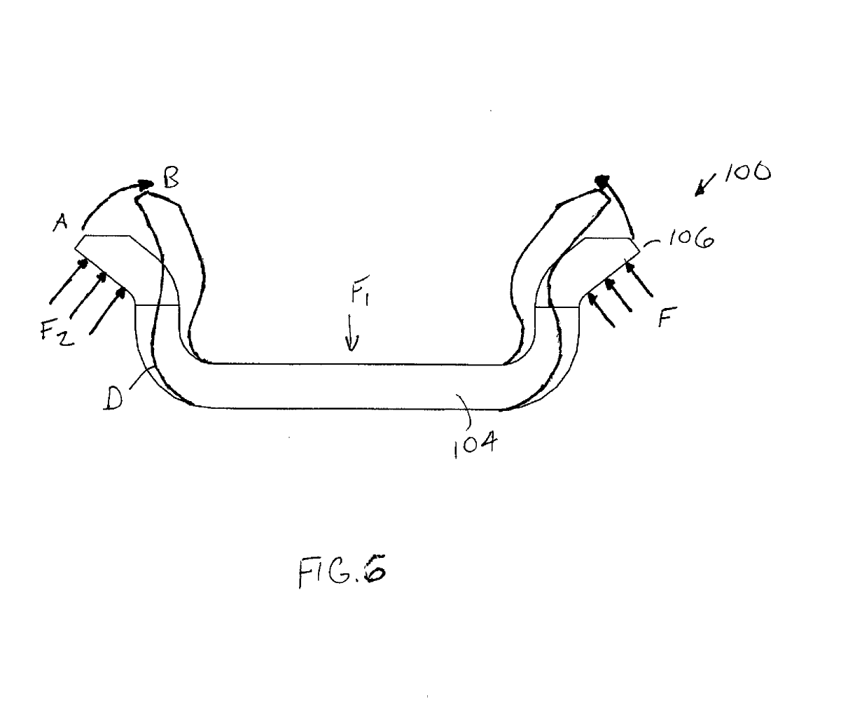

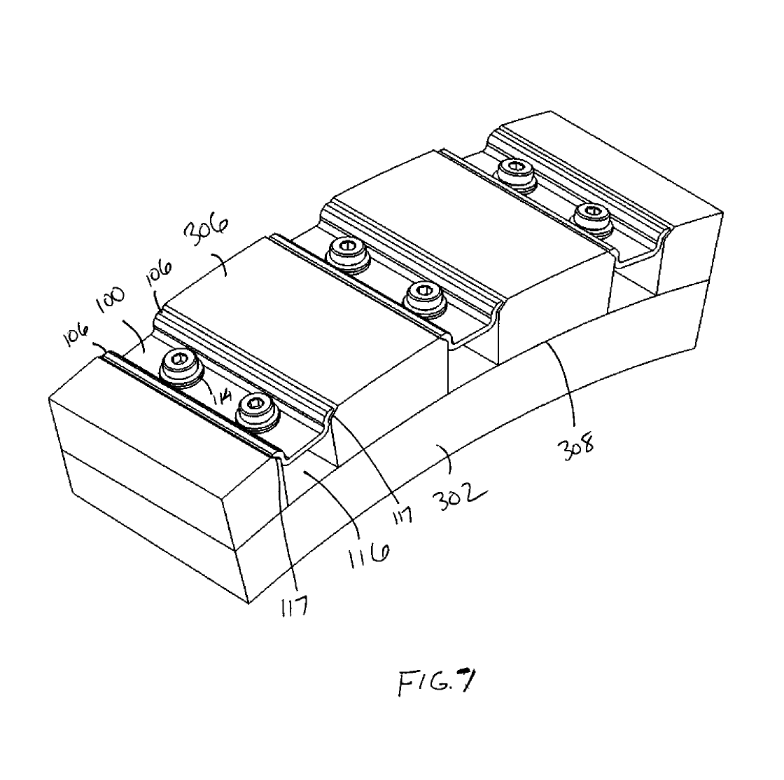

Elements of the retainer body 100, in particular, the bottom portion 104, the angled side surfaces 106, and/or the elbow bends between the side surfaces 110 and a bottom surface 108 of the bottom portion 104 can have spring displacement properties, which permit the angled side side surfaces 106 to move relative to the bottom surface 108. Each angled side surface 106 can have a top portion that extends, or bends, in a direction away from the bottom surface 108 of the bottom portion 104. In this manner, each side of the retainer body 100 can engage a surface of a neighboring magnet, for example, shown in FIGS. 6 and 7. Thus, the retainer body 100 can be coupled between adjacent magnets, and secure each adjacent magnet to a rotor body.

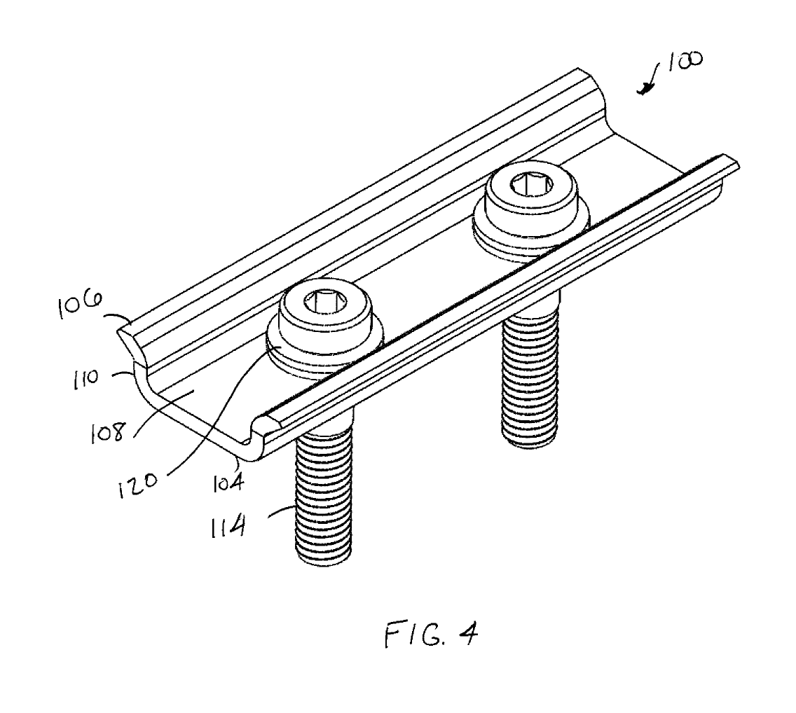

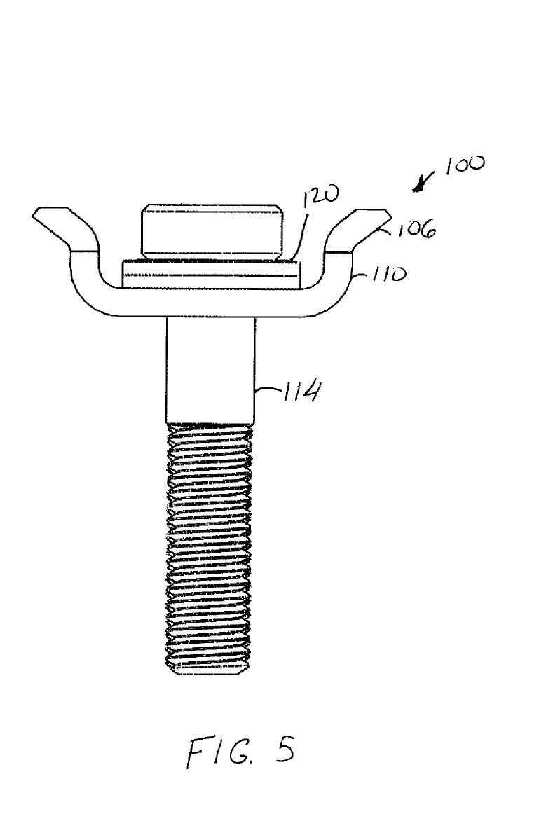

FIG. 4 is a perspective view of a plurality of bolts 114 positioned in openings of a retainer body 100, in accordance with an embodiment of the present inventive concepts. FIG. 5 is a front view of the retainer body 100 and the bolts 114 of FIG. 4.

The retainer body 100 can be positioned at a side of a magnet (not shown) to hold the magnet in place. As shown herein, the retainer body 100 can be positioned between two different magnets to hold a side of each magnet in place. In doing so, the retainer body 100 can be secured to a rotor body (not shown) using bolts 114 or other fastening devices that are disposed in openings 102 of the retainer body 100. A bolt 114 can include a head and an elongated body extending from the head. At least a portion of the body can be threaded. Accordingly, the bolt 114 can be disposed in the opening 120 of the retainer body 100 to secure the retainer body 100 against the rotor body, for example, by screwing the bolt 114 into the opening 120. The angled side surface 106 is positioned over, and abuts, at least a portion of the surface of the magnet so that the magnet is held in place against the rotor body.

One or more spring mechanisms 120, i.e., washers, springs and the like, can be disposed between the bolts 114 and the retainer body 100. In an embodiment, the spring mechanism 120 comprises at least one disc spring, also referred to as Belleville Washers, such as a disc spring provided by Belleville Springs, Ltd of the United Kingdom. The disc springs can be used in parallel or series combinations to obtain a desired spring constant. In some embodiments, the bolts 114 include radial bolts or the like that exert a centripetal force on the retainer body 100, which in turn exerts a centripetal force on at least one magnet of a neighboring pair of magnets. The bolts 114 can be advantageously secured by safety lock wiring at a radially inward end (not shown). The retainer body 100 is constructed and arranged to include an amount of spring displacement, thereby reducing a demand placed on the spring mechanisms 120 during operation of a rotor at which the retainer body 100 is positioned.

In an embodiment, the openings 102 can accept a fastening device such as a bolt 114 and a spring mechanism 120 between a top portion of the bolt 114 and a top surface of the retainer body 100 to secure the retainer body 100 to a rotor.

FIG. 6 is a front view illustrating a spring action performed by a retainer body 100 in response to a force applied to the retainer body 100, in accordance with an embodiment of the present inventive concepts. As described above, the angled side surface 106 and/or the U-shaped bottom portion 104 of the retainer body 100 can include elastic properties. Accordingly, the angled side surface 106 and/or the U-shaped bottom portion 104 can respond to a force applied thereto. After the force is reduced or ceases to be applied, the retainer body 100 can return to a shape at or close to a shape prior to application of the force.

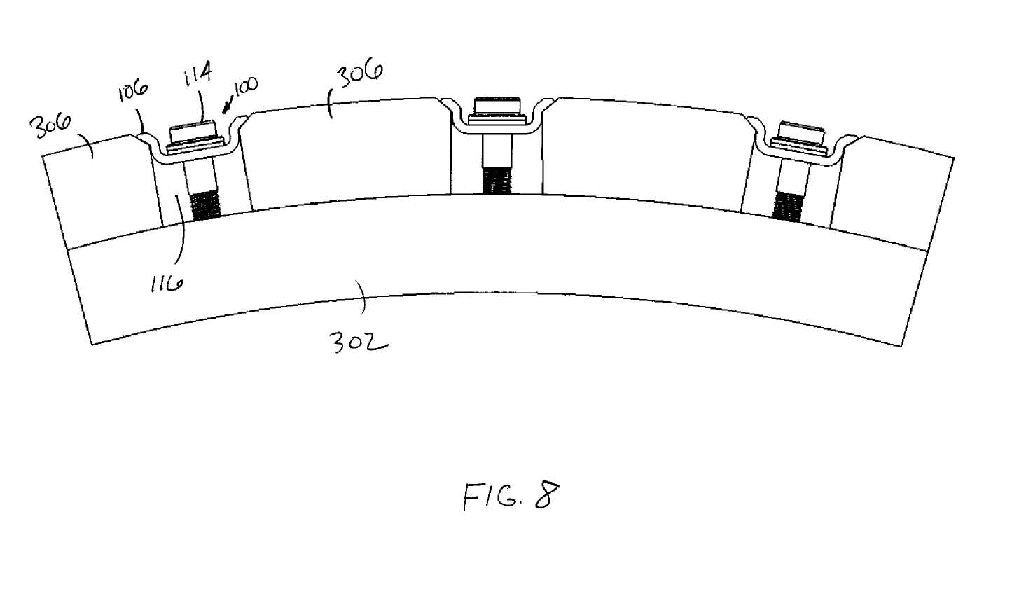

For example, a force F1 can be applied by a fastening element (not shown in FIG. 6), for example, the bolt 114 and spring mechanism 120 shown in FIGS. 4 and 5, to the surface of the retainer body 100 when the retainer body 100 is positioned against a magnet surface, for example, a magnet 306 shown in FIGS. 7 and 8. A force F2 applied by the magnet to the bottom surface of the angled side surface 106 of the installed retainer body 100 occurs when the retainer body 100 moves in a downward direction due to the applied force F1. The force F1 is applied by the tension of the fastener, which creates the reaction force, F2, on the magnet 306. When the rotor is spinning, and centripetal acceleration is applied to the magnet, the inertia of the magnet increases the magnitude of force F2, which in turn increases the magnitude of the force F1. A spring component is generated as shown by the movement of the angled side surface 106 from position A to position B. A rotation at the bend D between the bottom and side surface of the retainer body 100 can provide for a displacement, or a change in the bend angle at the bend D inside the retainer. Accordingly, less demand, or stress, is applied to the spring mechanism 120 between the bolt head and the surface 108 of the bottom portion 104 of the retainer body 100 as compared to a block-shaped retainer. More specifically, a reduction can occur on cyclical stress applied to the spring 120. Accordingly, a reduction in compliance required for in the spring mechanism 120 can result in design simplification.

Also, referring again to FIGS. 6-8, the abovementioned spring action allows for interfacing an angled surface of the magnet 306 to be controlled with low accuracy as compared to conventional block-shaped retainers. In particular, conventional block-shaped retainers require the angle between the machined stainless-steel flange and the magnet surface to be precise. The angled side surface 106 of the retainer body 100 in accordance with embodiments, however, can have a flange that is over-bent with respect to the angled or beveled surface or chamfer 112 of the magnet 306 that generates a preload to accommodate wider manufacturing tolerances than conventional retainers. When a force F1 is applied to the surface 108 of the bottom portion 104 of the retainer body 100, a preload can occur. Also, the retainer is constructed and arranged so that the angled side surface 106 conforms with the magnet surface, regardless of the angle of chamfer 112 of the magnet surface, so that that angled side surface 106 adjusts to be the same as the beveled magnet surface 112.

The retainer body 100 in communication with the spring mechanism 120 can maintain the centripetal force, and therefore the compressive force, at high rotation speeds and at varying operating temperatures. The spring mechanism 120 is disposed between the fastening device, e.g., a bolt 114, and the retainer body 100 and provides a force reactive to a centrifugal force during rotation of the rotor body. If the centrifugal force causes radial deflection of the magnet retainer 100, the spring mechanism 120 will tend to compress and exert a centripetal force on the retainer body 100, countering the centrifugal force.

FIG. 7 is a perspective view of a retainer 100 secured to a rotor 302 of an electric motor, in accordance with an embodiment of the present inventive concepts. FIG. 7 is a front view of the retainer 100 and the rotor 302 of FIG. 7. The retainer 100 can be the same or similar to the retainer 100 described with respect to FIGS. 1-6.

The rotor 302 has a cylindrical surface. Magnets 306 are attached to the rotor 302, preferably at equal intervals around the circumference of the cylindrical surface. Two magnets 306 can be attached at different axial positions at the same radial position, in effect forming a longer magnet. Each pair of magnets 306 has a retainer 100 disposed between the magnets 306. Two or more retainers 100 can be secured at different axial positions at the same radial position, in effect forming a longer retainer. Each retainer 100 can be secured to the rotor 302 with at least one bolt 114 or related attachment device, along with optional Belleville washers or the like.

The magnets 306 are positioned about the rotor 302. An adhesive layer (not shown) can be disposed between the magnets 306 and the rotor body 302. An axial retainer (not shown) can be secured to an end of the retainer 100, extending beyond the edges of the magnets 306, and preventing movement of the magnets 306 in an axial direction. One or more gap clearance regions 116 can extend between the retainer 100 and the cylindrical surface of the rotor 302. In preferred embodiments, the retainer 100 does not exert a centripetal force directly onto the cylindrical surface of the rotor body 302. Constructing and arranging the retainer 100 such that a gap clearance region 116 exists between the retainer body and the cylindrical surface ensures that no centripetal force can be exerted by the retainer body directly onto the cylindrical surface. In this manner, a centripetal force on the retainer 100 is exerted onto the magnets 306 via the engaged angled surfaces 106 of the retainer 100.

As shown in FIG. 8, the heads of the bolts 114 remain inside the arc created by the outer radius of the magnets 306. The bolt head clearance, i.e., not protruding from the circumference of the top surface of the magnet 306, maintains a tight radial clearance between the magnets 306 and a stator.

Therefore, the effect of the centripetal force provided by a bolt 114 or other fastening device holding the magnet retainers and magnets in place and producing the compressive force on the adhesive layer may be lessened during operation of the rotor. For example, the centrifugal force exerted on the retainers and magnets at high rotation speeds can be extreme. The centrifugal force is exerted in the opposite direction of the centripetal force, and therefore diminishes the effect of the centripetal force. Additionally, the rotor 302 is typically designed to work in different environments that can result in significantly different operating temperatures. For example, the retainer 110 can be constructed and arranged to accommodate for thermal expansion and contraction caused by different operating temperatures can reduce the centripetal force. Changes in both the centripetal and centrifugal forces during different operating conditions can induce peel stresses on the adhesive layer and may cause some radial deflection of the magnets.

While the present invention has been shown and described herein with reference to specific embodiments thereof, it should be understood by those skilled in the art that variations, alterations, changes in form and detail, and equivalents may be made or conceived of without departing from the spirit and scope of the invention. Accordingly, the scope of the present invention should be assessed as that of the appended claims and by equivalents thereto.

What is claimed is:

1. A rotor magnet retention device, comprising:
a retainer body, the retainer body including a bottom region and at least two angled side regions extending from the bottom region, the retainer body including at least one opening extending through a bottom surface of the retainer body; and
a fastening device that extends through the opening at a bottom surface of the retainer body to a rotor to flexibly position the retainer body relative to the rotor, wherein a first angled side surface conformably communicates with a first magnet coupled to the rotor and a second angled side surface conformably communicates with a second magnet coupled to the rotor.

2. The rotor magnet retention device of claim 1, wherein the retainer body has a stamped profile.

3. The rotor magnet retention device of claim 2, wherein the bottom region of the retainer body has a U-shaped profile.

4. The rotor magnet retention device of claim 1, wherein the retainer body is positioned in a gap between the first and second magnets, and wherein the bottom region of the retainer body is separated from a surface of the rotor by a clearance region in the gap.

5. The rotor magnet retention device of claim 1 wherein the retainer body comprises a nickel-based alloy.

6. The rotor magnet retention device of claim 5 wherein the nickel-based alloy includes at least one of Inconel or Monel.

7. The rotor magnet retention device of claim 1 wherein the fastening device includes a bolt and a spring mechanism, the spring mechanism positioned between a head region of the bolt and a surface of the retainer body.

8. The rotor magnet retention device of claim 7 wherein the spring mechanism includes one or more Belleville washer springs.

9. The rotor magnet retention device of claim 1 wherein the angled side surfaces each abuts a chamfered/beveled surface of at least one of the first or second magnets.

10. The rotor magnet retention device of claim 9 wherein the angled side surface has a different angle than an angle of the magnet surface, whereby the angled side surface of the retainer can flex, for example, displace, deform, or the like, to adapt to the magnet surface.

11. The rotor magnet retention device of claim 1 wherein the first and second angled side surfaces each includes an over-bent flange that generates a preload.

12. The rotor magnet retention device of claim 1 wherein a force applied to at least one of the first magnet or the second magnet by an angled side surface of the installed retainer body occurs when the retainer body moves in a downward direction due to a force applied by a tension of the fastening device.

13. The rotor magnet retention device of claim 1 further comprising a compliant layer between the magnet's angled surface and the angled surface of the retainer body that distributes a centripetal force more uniformly across the angle surfaces, limiting the contact stress concentrations.

14. The rotor magnet retention device of claim 13, wherein the compliant layer comprises an epoxy coating.

15. The rotor magnet retention device of claim 1, wherein at least one of the bottom surface, the first angled side surface, the second angled side surface, or an elbow bend between the bottom surface and the first angled side surface, or an elbow bend between the bottom surface and the second angled side surface includes a predetermined amount of spring displacement that reduces a demand placed on the fastening device.

16. A method for holding a magnet to a rotor, comprising:
positioning a retainer body between a first magnet and a second magnet, the first and second magnets each coupled to a rotor, the retainer body including a bottom region and at least two angled side regions extending from the bottom region, the retainer body including at least one opening extending through a bottom surface of the retainer body, a first angled side surface conformably communicating with the first magnet, a second angled side surface conformably communicating with the second magnet;
extending a fastening device through the opening at the bottom surface of the retainer body to the rotor;
applying a centrifugal force to the retainer body in response to a rotation of the rotor, which, in response moves in a direction towards the rotor;
generating, at the fastening device, a centripetal force on the retainer body that counters the centrifugal force.

17. The method of claim 16, wherein the retainer body has a stamped profile.
